(19) United States
(12) Patent Application Publication
(10) Pub. No.: US 2015/0061172 A1
(43) Pub. Date: Mar. 5, 2015

(54) PROCESS AND PLASTICS EXTRUSION APPARATUS FOR PRODUCING A HOLLOW BODY OR CAVITY FILLED WITH INSULATING FOAM

(71) Applicant: SIKA TECHNOLOGY AG, Baar (CH)

(72) Inventors: Herbert Ackermann, Tann (CH); Frank Hoefflin, Baden (CH); Andreas Brunner, Rafz (CH)

(73) Assignee: SIKA TECHNOLOGY AG, Baar (CH)

(21) Appl. No.: 14/385,097

(22) PCT Filed: Mar. 12, 2013
(86) PCT No.: PCT/EP2013/055030

§ 371 Date: Sep. 12, 2014

(30) Foreign Application Priority Data
Mar. 20, 2012 (EP) 12160372.4

(51) Int. Cl. B29C 44/24; B29C 44/36

(52) U.S. Cl. CPC B29C 44/24; B29C 44/367; B29K 2105/04
USPC 264/45.9; 425/131.1

(57) ABSTRACT

A process is described for producing a hollow body or cavity filled with insulating foam. The process can include feeding an expandable starting material of the insulating substance to a plastics extrusion apparatus, activating the material therein under pressure and, upon discharge therefrom into the hollow body or the cavity, expanding the material with such a high volume expansion gradient that the insulating substance formed by the expansion completely fills the cross section of the hollow body or cavity without delay upon entry. Also described, is a plastics extrusion apparatus.

### TECHNICAL FIELD

The invention relates to a method for producing a hollow body or hollow space foamed with insulation material, the hollow body or hollow space being in particular of an extruded profiled part made of plastic material, as well as to a plastic extrusion apparatus for carrying out this method.

### PRIOR ART

In a great variety of technical fields, the insulation—both heat insulation and also acoustic insulation—of hollow spaces or hollow bodies by means of foamed materials has been known for a long time. Depending on the geometric configuration of the hollow space or hollow body to be insulated and on the processing properties of the material used, the foam here can in principle be inserted as a separate prefabricated part into the hollow space or hollow body, or it can be introduced in a non-expanded starting state at the application site where it is caused to expand, in particular to foam.

The two basic procedures have also been disclosed for manufacturing window or door profiles filled with insulation material: either a separate profiled part is produced from the corresponding insulation material and introduced into the prefabricated frame profile, or starting material is sprayed into the frame profile where it is allowed to expand after an appropriate activation. A method of the last type is, for example, the subject matter of WO 2009/062986 A1 of the applicant. Therein it is also proposed in particular to activate the expandable starting material for the formation of the filler material which fills out the profile due to the heat loss of the practically simultaneously extruded frame profile.

In particular from the viewpoint of a manufacturer of windows or doors, the two basic solutions have certain disadvantages; in particular, they are logistic disadvantages for the first variant, and, for the second variant, the disadvantage pertains to the demanding methods of the plastics technology that have to be carried out in a manufacturer's own plant and require the availability of appropriate equipment.

### DISCLOSURE OF THE INVENTION

The invention is based on the problem of providing improved methods, in particular from the viewpoint of the user or further processor, for producing a hollow body or hollow space foamed with insulation material, the hollow body or hollow space being in particular of an extruded profiled part made of a plastic material. In addition, a device for carrying out this method is to be provided.

This problem is solved in terms of its process aspect by a method having the features of Claim 1 and in terms of its apparatus aspect by a plastic extrusion apparatus having the features of Claim 9. Advantageous variants of the idea of the invention are the subject matter of the respective dependent claims.

The invention differs from the two above-outlined basic procedures and it includes the consideration of finding, in a manner of speaking, a synthesis of the two. Moreover, it includes the idea of doing this by an activation of the starting material of the insulation material already in an apparatus used for the application of same, and, on the other hand, the idea of designing the outlet of this apparatus in such a manner that the activated starting material is expanded immediately there—and not only after a delay compared to the time of the application—in the hollow space or hollow cavity. Thus, the already expanded insulation substance collides so to speak with the prefabricated hollow body or the existing hollow space, without having existed beforehand as an independent body elsewhere, and without having had to be handled.

This makes it possible to provide foamed hollow bodies or hollow spaces with efficient utilization of the capacity of mass production technology and without inserted processes for handling and storing separate parts. This in turn allows a considerable simplification of the production and cost savings, particularly during the further processing of correspondingly manufactured profiled parts, and thus it makes it possible, on the one hand, for the manufacturer of profiled parts to use these user advantages to gain market shares and/or to take into consideration in his pricing the higher added value created at his facility. In addition, the proposed manufacturing process allows a superior and uniform process and quality control during the manufacture of insulated hollow bodies, in particular insulated frame profiles, and thus leads to a reliable product quality for the end user.

In an embodiment of the method according to the invention, it is provided that the plastic extrusion apparatus is supplied, like an extruder or an injection molding machine, with solid starting material in granulate form. Solid granular starting material can easily and cost effectively be packaged, stored and processed with little residue and thus it offers considerable advantages compared to liquid or pasty formulations.

In a design that is of special interest currently with regard to environmental protection aspects and economically, the hollow body is an extruded profiled part made of a plastic material, and the insulation material is introduced in a coextrusion process at the same time as the formation of the profiled plastic part. In principle, the invention is also usable with extruded profiled metal parts for window and door frames and furthermore with products of another type, for example, for in-situ sealing of joints or insulation of hollow spaces in parts of a structure or for the joint sealing and the insulation of profiled parts or other hollow spaces in vehicle, aircraft and ship construction.

In a further embodiment of the invention, it is provided that a plastic extrusion apparatus with at least one screw conveyor is used, and that the plastic extrusion apparatus is configured in such a manner, and the mechanical properties of the starting material are predetermined in such a manner, that high pressures and/or shearing forces occur, which contribute to a thermal activation of the starting material. In this embodiment, it is possible, under some circumstances, to dispense with an additional heating device of the plastic extrusion apparatus, and to operate in a particularly energy-saving manner. In an additional embodiment, a plastic extrusion apparatus with a heating device is used, and the heating device is operated in such a manner that it at least contributes to a thermal activation of the starting material. A combination of the two ways of activating the starting material is also possible.

In a further embodiment of the invention, the process of expansion of the starting material at the time of the discharge from the plastic extrusion apparatus is controlled by a special nozzle geometry, in particular in the form of an additional part of the plastic extrusion apparatus that is attached on the outlet side. Nozzle geometries that are adapted to an application and tailored to the special insulation material (or its starting material) allow a precise control of the expansion process, and the implementation in the form of an additional part added to the spraying apparatus itself makes it possible to provide different adapted nozzle geometries and to allow rapid and cost effective change in the case of production switches, which can occur by using another insulation material or other profile geometries, etc.

The implementation of a special design consists, as a result of the nozzle geometry, first of a gradual cross-section reduction with small gradient over a large length, then of maintaining the cross-section constant over a small length, then of a gradual cross-section reduction with large gradient over a small length, subsequently of a gradual cross-section increase with medium gradient over a medium length, and finally of an exit through a spray head with a plurality of spray openings. This sectional subdivision of the nozzle is an advantageous implementation from the present viewpoint; however, it should be pointed out that all the mentioned sections with the respective mentioned phases with the respective associated geometric characteristics do not necessarily have to be present.

The apparatus aspects of the invention result largely directly from the above-explained process aspects and to that extent they are not explained again in detail here. However, the following must be pointed out:

In an advantageous embodiment, the proposed plastic extrusion apparatus is provided with an outlet-side nozzle arrangement that is suitable for the expansion of a preactivated starting material with high volume expansion gradients. Although the expansion of the preactivated starting material can in principle occur beyond the outlet of the plastic extrusion apparatus—limited, for example, by the walls of the hollow body or hollow space into which the material expands—, it makes sense, from the present viewpoint, to provide means for controlling the expansion step, which affect at least the initial phase, within the spraying apparatus or (as already mentioned above) in the form of an additional part added to said spraying apparatus.

On the outlet side of the plastic extrusion apparatus, it is possible to provide a die plate or also a grid or mesh for the appropriate distribution and/or shaping of the expanded material stream, and by way of a special cross-section design of the nozzle—for example, with expanded corner areas and/or a nozzle core—it is possible to achieve that even the corner areas of profiled parts having edged and angular shapes are also largely filled with insulation material.

### DESCRIPTION OF THE DRAWINGS

Advantages and advantageous uses of the invention result moreover from the following description of embodiment examples and aspects, partially in reference to the figures.

FIG. 1 shows a diagrammatic representation for explaining an embodiment of the method according to the invention, in the form of a longitudinal sectional representation through a coextrusion arrangement,

FIG. 2 shows sketch-like cross-sectional representations of a simple profile geometry and of nozzle cross-sections of a plastic extrusion apparatus according to the embodiment of the invention,

FIGS. 3A and 3B show diagrammatic representations (longitudinal sectional representation) with graphic representation of an associated pressure curve (FIG. 3A) and cross-sectional representations along a section plane in FIG. 3A (FIG. 3B) for explaining an additional embodiment of the invention,

FIGS. 4A and 4B show diagrammatic representations (longitudinal sectional representation) with graphic representation of an associated pressure curve (FIG. 4A) and cross-sectional representations along a section plane in FIG. 4A (FIG. 4B) for explaining an additional embodiment of the invention,

FIGS. 5A and 5B show diagrammatic representations (longitudinal sectional representation) with graphic representation of an associated pressure curve (FIG. 5A) and cross-sectional representations along a section plane in FIG. 5A (FIG. 5B) for explaining an additional embodiment of the invention,

FIGS. 5C and 5D show diagrammatic representations of an additional embodiment,

FIGS. 6A to 6D show longitudinal cross-sectional representations and a top view, respectively, of an additional part of a plastic extrusion apparatus according to an additional embodiment of the invention, and

FIGS. 7A and 7B show a longitudinal sectional representation and a perspective view, respectively, of an additional part of a plastic extrusion apparatus according to an additional embodiment of the invention.

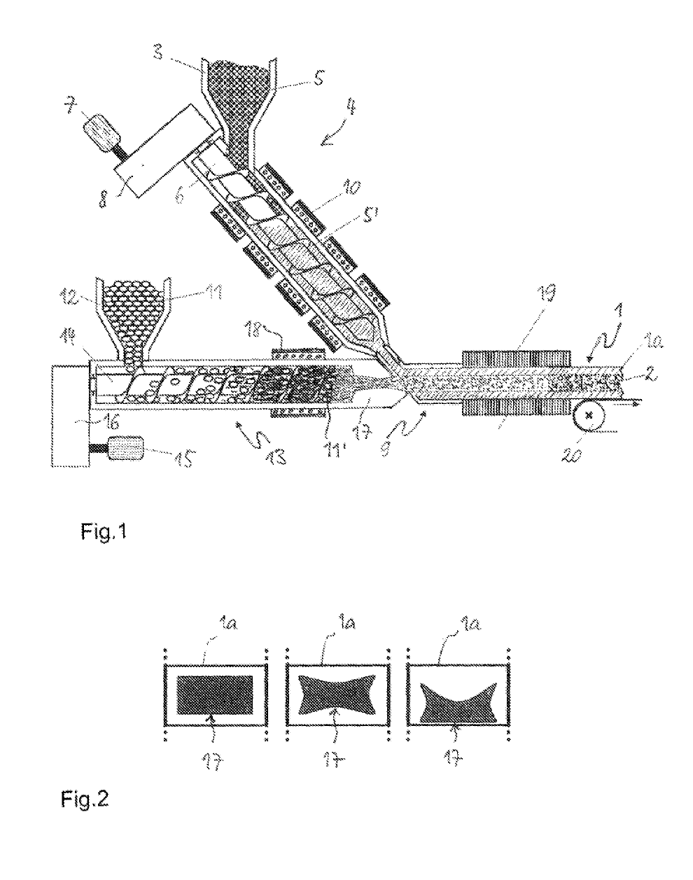

In FIG. 1, a coextrusion method according to the invention for manufacturing profiled plastic parts 1 with a foamed insulation core 2 is represented diagrammatically.

In the process the funnel 3 of a first extruder 4 is filled with a solid, thermoplastically processable plastic 5. This plastic can be in any desired form. In particular, the plastic is in the form of a granulate or powder. The plastic is preferably extruded at a temperature of 150° C. to 350° C., in particular of 170° C. to 260° C., preferably of 180° C. to 220° C. The plastic 5 reaches the interior of the first extruder 4 through the funnel 3. Here, the plastic is conveyed by means of a screw conveyor 6, which is operated by a motor 7 via a transmission 8, in the direction of a nozzle 9, and at the same time it is heated from the outside by heating elements 10, which are arranged on the first extruder, to a temperature above its melting point, resulting in the melting of the plastic. The molten plastic 5′ is pressed through the nozzle 9, which has the cross-sectional shape of the profile to be manufactured.

In parallel, a foamable material 11, in particular in the form of a granulate, is filled into the funnel 12 of a second extruder 13 and it then reaches, through said funnel, the interior of the second extruder. The foamable material is conveyed by means of a screw conveyor 14 which is driven by a motor 15 via a transmission 16 in the direction of a nozzle 17. By means of an appropriate geometric configuration of the screw and of the screw cylinder, high pressures and shearing forces are generated in a targeted manner in the process, leading to a softening and to an activation of the originally solid granulate, and an additional heating device 18 supports this process.

At the nozzle 17, the activated foamable material 11′ is coextruded with a nearly immediate expansion, which is controlled by a special geometric configuration of the nozzle, into the hollow space of the hollow profiled plastic part 1a, where it comes in contact with the inner walls of the plastic hollow profile. The introduction of the profiled plastic part 1 into a calibration device 19 here should ensure that the hollow profiled plastic part is not deformed by the pressure of the foamed material up to the setting of the plastic, but rather keeps its predetermined cross-sectional shape.

After the calibration device 19, the profiled plastic part 1 optionally passes through a separate cooling device, wherein it reaches, for example, a water bath or is sprayed by water showers. At the end of the coextrusion process, the profiled plastic part 1 is pulled off via a pull-off device 20 at a constant speed adapted to the delivery rate of the extruder.

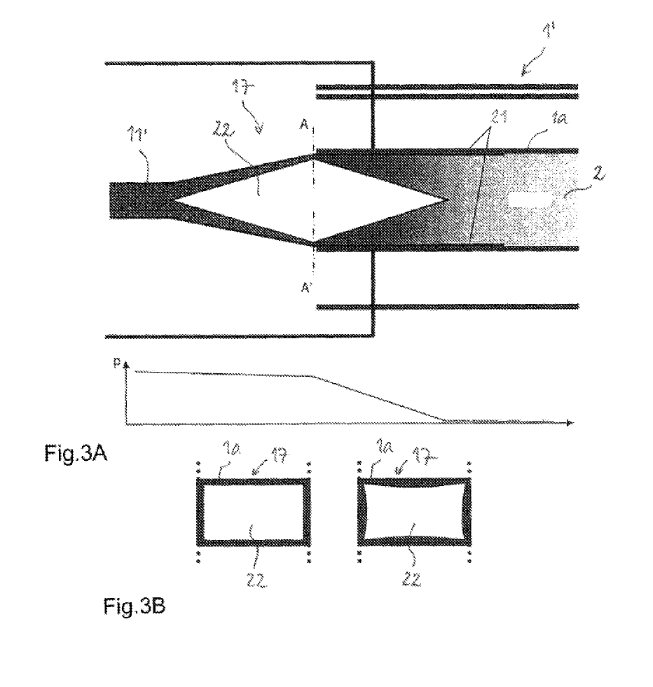

Below, in reference to FIGS. 2-7B, embodiment examples and aspects of the method according to the invention and of a plastic extrusion apparatus that can be used for this are explained. When appropriate, reference is made here to parts shown in FIG. 1, and these parts are designated with the reference numerals according to FIG. 1 or reference numerals based thereon.

FIG. 2 shows in three diagrammatic cross-sectional representations in each case the wall 1a of a plastic profiled part having a rectangular cross-section, with examples of cross-sectional shapes of a form-imprinting section of the nozzle 17 of the second extruder according to FIG. 1. In the left representation, the cross-sectional shape of the nozzle 17 corresponds to that of the profiled part. In order to achieve an improved filling of such a profiled part in the corner areas, modifications of the cross-sectional shape of the nozzle are proposed, which can be seen in the middle representation and in the right representation. The two modifications have in common a contraction of the nozzle shape in the middle regions of the delimitation surfaces or, in other words, a butterfly-like expansion toward the corner areas.

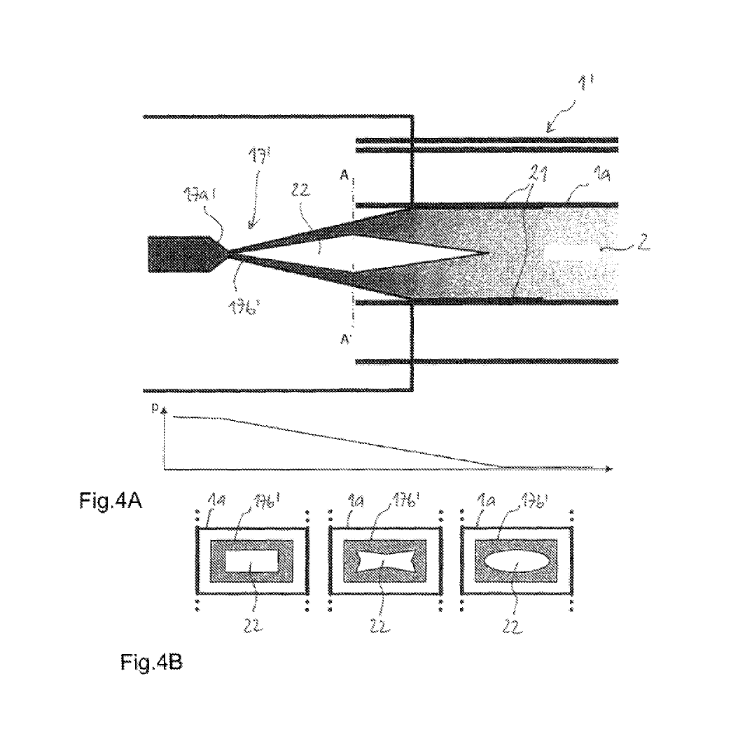

FIGS. 3A and 3B show examples of geometries of a discharge nozzle 17 in a diagrammatic longitudinal and cross-sectional representation together with a profiled plastic part 1′, which is subdivided into several chambers, with an insulation core 2 in one chamber. At the outlet of the nozzle, steel guide plates 21 are provided in addition here for the lateral delimitation of the expanding insulation material even after the exit from the nozzle and for reducing its adhesion to the profile wall. In the nozzle itself, a nozzle or spray core (mandrel) 22 for pre-imprinting the shape is provided, in which the activated starting material 11′ expands to form the finished insulation material 2. In FIG. 3A, one can see that the nozzle core 22 is shaped in the form of a double cone in the longitudinal extent, and FIG. 3B shows, as a cross-sectional representation along the section plane A′ in FIG. 3A, two different cross-section shapes (based on the left and middle variant in FIG. 2). The graphic representation in the bottom part of FIG. 3A shows the pressure curve at the outlet of the plastic extrusion apparatus.

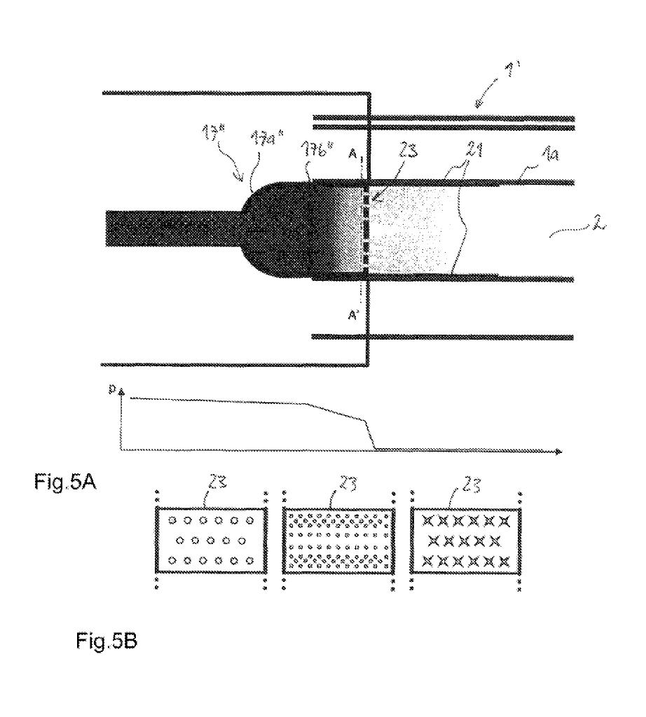

FIGS. 4A and 4B show a similar nozzle arrangement to that of FIGS. 3A and 3B in connection with the same plastic profiled plastic part 1′. The essential differences are that the nozzle core 22, in its central dimensions, is dimensioned considerably smaller here, and that the nozzle 17′ (in addition to a first section having a constant diameter, which is not designated separately) has a constriction section 17a′ with an adjoining expansion section 17b′, wherein the slender nozzle core 22 sits in the latter section. In the lower portion of FIG. 4A, the pressure curve is again represented, and FIG. 4B shows three examples of cross-section geometries of the nozzle 17′ and of the nozzle core 22 along the section plane A′. Thus, the cross-section of the nozzle core here is rectangular or butterfly-shaped or elliptic, as a result of which different effects with regard to the filling of the profiled plastic part with an insulation material can be achieved.

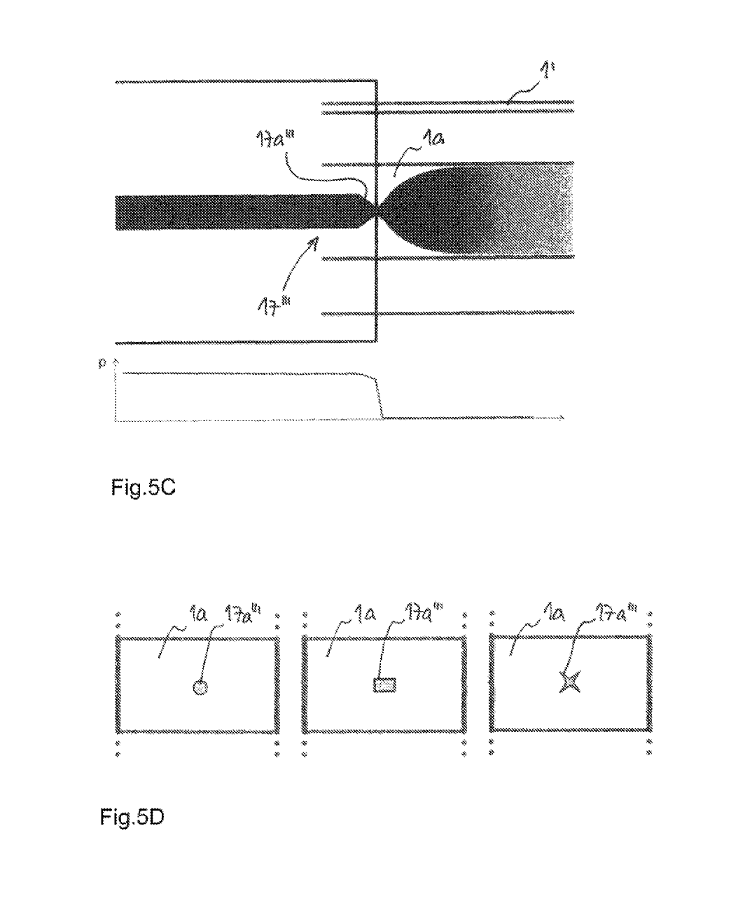

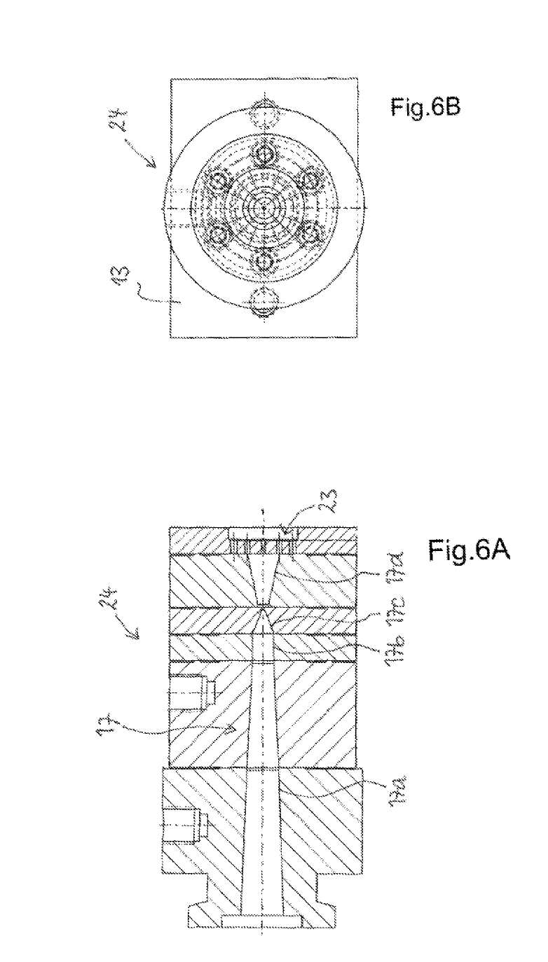

FIGS. 5A and 5B show, as a fundamentally different embodiment, a nozzle 17″ of a plastic extrusion apparatus according to the invention, which delivers the expanding insulation material through a perforated sheet (strainer) 23, shown again in connection with the profiled plastic part 1′ already shown in FIGS. 3A and 4A. The nozzle 17″ here includes, in addition to the feed section having a constant diameter, an approximately hemispherical expansion section 17a″, which transitions into a cylindrical section 17b″ of larger diameter. At its end, and thus directly at the outlet of the nozzle 17″, the perforated sheet 23 is located, for which three different embodiments are shown in FIG. 5B. The right representation differs from the two other representations in that the openings of the perforated sheet in cross-section are not circular but stellate.

FIG. 5C shows, as an additional embodiment, a nozzle 17′″, which comprises a constriction section (section with rapidly linearly decreasing diameter) 17a′″, and in that respect corresponds to the nozzle 17′ of FIG. 4A. However, in the present embodiment there is no nozzle core; instead the insulating material 2 exiting from the constriction section 17a′″ expands, without a central guide, into the central chamber 1a of the profiled plastic part 1′ which has the same shape as the embodiment according to FIGS. 3A and 3B. From the diagram, in the lower part of the figure, one can see that the pressure decrease here occurs more rapidly than in the embodiment according to FIGS. 3A and 3B. FIG. 5D shows, in a synoptic representation, several nozzle cross-sections (cross-sections of the end of the constriction section 17a′″), in relation to the wall of the central profile chamber 1a.

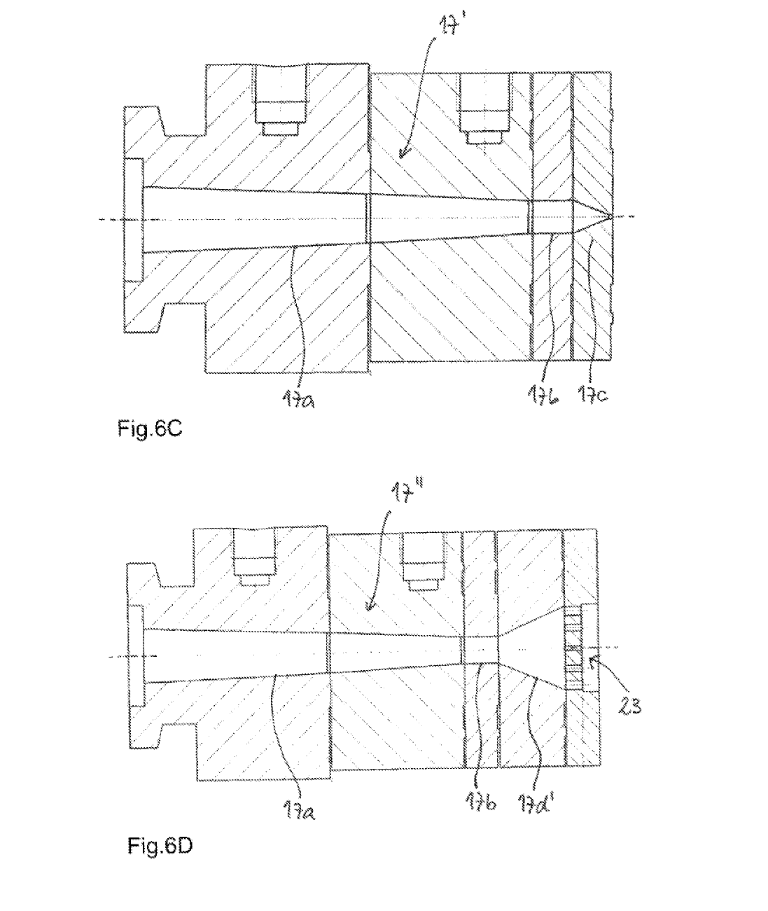

FIGS. 6A and 6B show a special nozzle design of the plastic spraying apparatus according to the invention, which is implemented in the form of an additional part 24 to be inserted at the apparatus outlet. In FIG. 6A, one can see that the nozzle arrangement has a first nozzle section 17a of large length in which the nozzle cross-section decreases continuously with small gradient, a second nozzle section 17b of small length in which the cross-section remains constant, a third nozzle section 17c of small length in which the nozzle cross-section decreases with large gradient, a fourth nozzle section 17d of medium length in which the nozzle cross-section increases with medium gradient, and a fifth nozzle section 23 with a plurality of spray openings. Moreover, one can see that, for the implementation of these nozzle sections, the additional part 24 is subdivided into a plurality of separate plates (not designated separately), wherein the first nozzle section 17a is implemented by two plates or base bodies mutually adjoined in the longitudinal direction. As a result of this modular structure, it is relatively easy to implement variations of the nozzle geometry in certain sections, without having to produce a whole new additional part 24.

FIGS. 6C and 6D show additional embodiments of a special nozzle structure for shaping the insulation material flow in the extrusion apparatus. In both embodiments, in any case, the nozzle sections 17a and 17b have substantially the same function with respect to one another and compared to the embodiments according to FIGS. 6A and 6B. In the case of the nozzle 17′ according to FIG. 6C, the nozzle section 17b with constant width—in the same way as in the embodiment according to FIG. 6A—is followed by a section 17c in which the width of the insulation material discharge channel decreases with high gradient. The narrow end of the nozzle section 17c in this embodiment is at the same time the discharge opening of the nozzle. In the case of the nozzle 17″ according to FIG. 6D, on the other hand, the nozzle section 17B with constant width is followed immediately by a nozzle section 17d′ with increasing diameter, and on the latter nozzle section, on the outlet side, a strainer 23 is arranged. In that respect the embodiment according to FIG. 6D resembles that of FIG. 6A, but in the present case the narrowing nozzle section at the inlet side of the expanding nozzle section 17d′ has been omitted, and the end cross-section of the expanding nozzle section is selected so that the discharged insulation material passes through all the openings of the strainer 23.

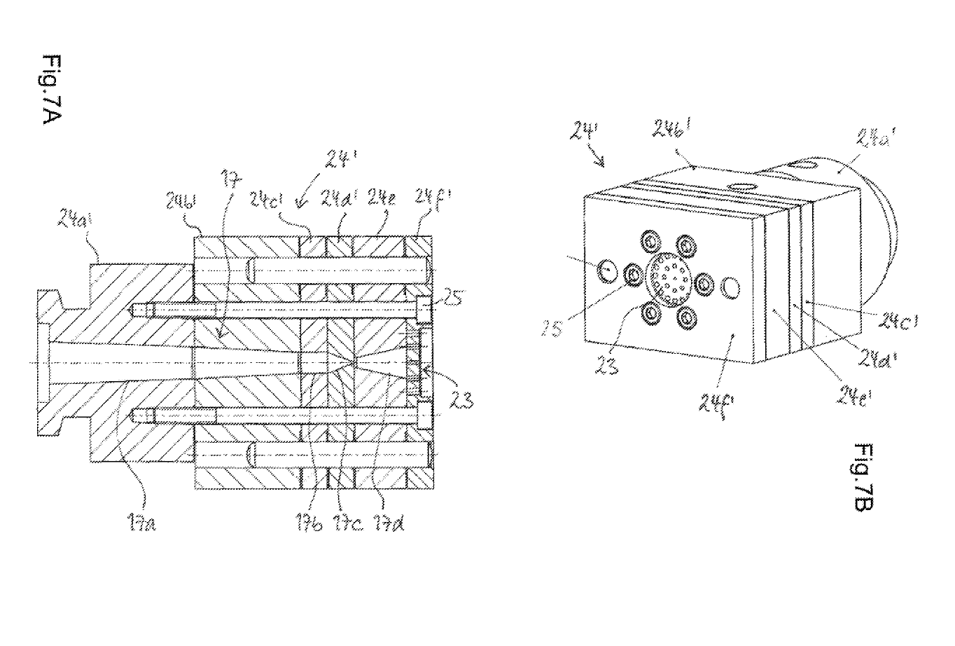

FIGS. 7A and 7B show an additional part 24′ which is modified compared to the above-described embodiment and which is constructed so that it can be attached to the outlet of the plastic extrusion apparatus 13. By means of this additional part 24′, the same geometry of the nozzle arrangement 17 as in FIG. 6A is implemented in principle, so that the nozzle sections are designated with the same reference numerals as there. In FIGS. 7a and 7B, the modules that constitute the additional part 24′ are designated with the numbers 24a′ to 24f′, and the attachment bolts 25 for the attachment of the modules are also designated.

A means for implementing the invention is a foamable composition which includes at least one base polymer, at least one propellant as well as at least one lubricant and/or at least one heat stabilizer. The content of the base polymer should here preferably be at least 50% by weight. Moreover, the polymer should preferably be selected so that it is not compatible with the plastic of the profiled part and does not adhere to said plastic during foaming. In order to ensure sufficient foaming, a content of propellant in the range of 5 to 20% by weight has been found to be advantageous. The lubricant and/or the heat stabilizer is/are contained in the foamable composition in quantities of 0.1 to 5% by weight, relative to the foamable composition. By means of such a composition, polymer foams with a thermal conductivity of <0.04 W/(mK), an expansion of ≧1000%, in particular ≧2000% and/or a weldability of approximately 80 sec at 240 to 260° C. can be obtained.

As base polymer of the foamable composition, which can be used in the present invention and in particular for producing cores of profiled plastic parts, it is possible in principle to use any desired material which can be made to foam in a controlled manner and which has reinforcement properties. The base polymer should preferably be incompatible with the material of the profiled part and not adhere to said material. It is particularly preferable for the foamable composition introduced into a profile not to adhere to PVC.

However, the base polymer is preferably an organic polymer having a melting point in the range of 20 to 400° C. The base polymer should advantageously soften at a temperature that is below the foaming temperature and allows its deformation during the foaming process. Once the foaming temperature has been reached, the base polymer is foamed. It is particularly preferable for the base polymer to have a melting point in the range of 60-200° C. Moreover, the curing process should preferably start only once the foaming temperature has been exceeded and the foaming has been completed at least partially.

The person skilled in the art is readily familiar with suitable base polymers. In the context of the present invention, it is particularly preferable to select the base polymer from the group including EVA, polyolefin, polyvinyl chloride or XPS (crosslinked polystyrene). Preferred polyolefins are ethylene- or propylene-based polymers, among which polyethylene, particularly in the form of LDPE (low density polyethylene), is particularly preferred. Mixtures of the mentioned polymers can also be used as base polymer in the context of the invention. It should be noted that in the case of the use of PVC foams with profiled PVC parts, pure PVC is less suitable as base material for the foam. However, it has been found that it is possible to fabricate PVC with other polymers, in particular with a terpolymer made of ethylene, n-butyl acrylate and carbon monoxide, so that the foamable composition does not adhere to the material of the profiled part. Such mixtures are therefore preferable in the context of the invention for use with profiled PVC parts.

The base polymer as a rule represents the main component of the foamable composition, wherein the proportion thereof in the composition is preferably at least 50% by weight. It is particularly preferable for the content of base polymer to be in the range of 65 to 95% by weight, in particular in the range of 70 to 90% by weight, and most preferably in the range of 75 to 85% by weight.

The foamable composition can be foamed thermally or by electromagnetic radiation. For this purpose, the foamable composition typically contains a chemical or physical propellant. Chemical propellants are organic or inorganic compounds that decompose under the influence of temperature, moisture or electromagnetic radiation, wherein at least one of the decomposition products is a gas. As physical propellants it is possible to use, for example, compounds that transition at increased temperature into the gaseous state of matter. As a result, both chemical and also physical propellants are capable of generating foam structures in polymers.

In connection with the present invention, it has been found to be particularly advantageous if the foamable composition is thermally foamable and is foamed at a temperature less than or equal to 250° C., particularly at a temperature of 100° C. to 230° C., preferably of 140° C. to 200° C., wherein chemical propellants are used. It has been found to be particularly advantageous to use azodicarbonamides, sulfohydrazides, hydrogen carbonates or carbonates as chemical propellants. Suitable sulfohydrazides are p-toluenesulfonyl hydrazide, benzenesulfonyl hydrazide and p,p′-oxobisbenzenesulfonyl hydrazide. A suitable hydrogen carbonate is sodium hydrogen carbonate. A particularly preferred propellant is p,p′-oxybisbenzenesulfonyl hydrazide. Suitable propellants are also commercially available under the trade name Expancell® from the company Akzo Nobel, The Netherlands, under the trade name Cellogen® from the company Chemtura Corp., USA, or under the trade name Unicell® from the company Tramaco, Germany.

The heat required for the foaming can be supplied by external or by internal heat sources, such as an exothermic chemical reaction.

With regard to the content of propellant, the present invention is not subject to any relevant restrictions. However, it has been found to be advantageous if the propellant is contained in the foamable composition at a content of 5 to 20% by weight, in particular of 10 to 18% by weight, and particularly preferably in the range of 12 to 16% by weight, relative to the foamable composition. In cases in which a lower expansion value of the composition is desirable, the content can also be lower, in particular it can be in the range of 5 to 10% by weight.

The foamable composition from which the polymer foam can be produced contains, as described above, also at least one lubricant and/or at least one heat stabilizer. In a preferred embodiment, the foamable composition contains a component which at the same time has the properties of a lubricant and also those of a heat stabilizer. In this case, it is possible to dispense with the use of an additional lubricant or heat stabilizer component.

As heat stabilizers that confer at the same time a lubricant effect to the foamable composition, it has been found to be particularly suitable to use in particular fatty acid amides, fatty acids and fatty acid alcohol esters whose long aliphatic carbon chains produce the desired lubricant effect. At the same time, these compounds function as heat stabilizer. It has been found to be particularly advantageous to use fatty acid amides, fatty acids and fatty acid alcohol esters that have a chain length of the portion due to the fatty acid or to the fatty acid alcohol in the range of 6 to 24, preferably 8 to 16, and in particular 10 to 14 carbon atoms.

In the context of the invention, heat stabilizers comprising a thioether function in addition to a linear aliphatic chain have been found to be particularly suitable. Most preferable as heat stabilizers are fatty acid alcohol diesters in which a thioether function is present in the acid portion, in particular didodecyl 3,3′-thiodipropionate.

The heat stabilizer should be contained in the composition at least in a quantity at which a significant stabilization of the composition after the foaming is observed, i.e., so that the foam is not subjected to a significant volume reduction (10% or more) even in the case of longer exposure (10 minutes or longer) to high temperatures (150° C. or more). In the context of the present invention, a content of the heat stabilizer and/or of the lubricant in the range of 0.1 to 5% by weight, and preferably in the range of 0.5 to 3% by weight, relative to the total foamable composition, has been found to be particularly suitable. In the case of contents of less than 0.1% by weight, the quantity of the heat stabilizer is not sufficient to stabilize the foam, whereas in the case of contents of more than 5% by weight a significant decrease of the foam volume is also observed in the case of longer exposure of the foam to high temperatures.

Moreover, it has been found to be advantageous if the foamable composition is stabilized and consolidated during the foam formation. This can be ensured by adding crosslinking agents that are preferably activated by degradation products of the propellant and trigger a crosslinking of the forming foam. Here, the curing of the foamable composition should start only at a temperature that is equal to or higher than the foaming temperature thereof, because otherwise the curing of the foamable composition occurs before foaming thereof, and as a result it would not be possible to ensure that the foamable composition has filled the entire hollow space of the profiled plastic part before the curing and that the foam has a compact structure.

With regard to the crosslinking of the polymer foam obtained, the present invention is also not subject to any relevant limitations. A crosslinking of the foam is possible particularly by means of crosslinking agents, which do not react with the base polymer, such as, for example, epoxy-based crosslinking agents, or by means of crosslinked epoxides, which react with the base polymer. Peroxide crosslinking agents are an example of such a crosslinking agent. In the context of the present invention, a crosslinking with peroxide crosslinking agents or a crosslinking with epoxides is preferred.

In the crosslinking with peroxides, it is possible conventional organic peroxides, such as, for example, dibenzoyl peroxide, dicumyl peroxide, 2,5-di-(t-butylperoxyl)-2,5-dimethylhexane, t-butyl cumyl peroxide, a,a′-bis(t-butylperoxy)diisopropylbenzene isomer mixture, di(t-amyl) peroxide, di-(t-butyl) peroxides, 2,5-di-(t-butylperoxy)-2,5-dimethyl-3-hexyne, 1,1-di(t-butylperoxy)-3,3,5-trimethylcyclohexane, n-butyl 4,4-di-(t-butylperoxy)valerates, ethyl 3,3-di-(t-amylperoxy)butanoates or t-butyl peroxy-3,5,5-trimethyl hexanoates can be used. Dicumyl peroxide is a preferred peroxide.

When using epoxy-based crosslinking agents, a mixture of an epoxy-containing polymer and of a maleic acid anhydride group-containing polymer has been found to be particularly advantageous. The epoxy-containing polymer is preferably a polymer made of ethylene and glycidyl methacrylate with a glycidyl monomer content in the range of 4 to 12% by weight. The maleic acid anhydride group-containing polymer consists preferably of a terpolymer made of ethylene, an acrylic acid alkyl ester, in particular based on an alkyl alcohol having 2 to 10 carbon atoms, and maleic acid anhydride. The content of maleic acid anhydride in the terpolymer is preferably in the range of 1.5 to 5%. It is particularly preferable for these two crosslinking agent components to be present in a ratio from 2:1 to 1:2, particularly approximately 1:1.

This polymer combination has been found to be particularly advantageous especially in combination with propellants during the heating of which water or alcohol is released, since, due to the forming water or the alcohols, the maleic acid anhydride groups can be hydrolyzed to maleic acid, which in turn undergoes a reaction with the epoxy groups of the epoxy-containing polymer and brings about a crosslinking. In the foamable composition, the crosslinking agent is contained preferably at a content of 1 to 25% by weight, in particular in the range of 2 to 18% by weight and particularly preferably in the range of 2 to 10% by weight, relative to the total foamable composition. However, if a peroxide is included as crosslinking agent then its concentration can also be lower, in particular in the range of 1 to 5% by weight and particularly preferably in the range of 1 to 2% by weight.

In a further preferred embodiment, the foamable composition is free of crosslinking

agents.

Moreover, it has been found to be advantageous if, in addition, at least one heat reflector, at least one heat loss additive, at least one anticondensation additive, at least one antioxidant, urea and/or at least one filler is/are included the foamable composition. Graphite, carbon black and/or titanium dioxide represent(s) advantageous heat reflectors. Advantageous fillers to be included in the polymer foam are calcium carbonate or talc, which can be contained at a content from 0.5 to 8% by weight, in particular 1 to 5% by weight, and particularly preferably in a quantity of approximately 2% by weight, in the polymer foam. Fillers can be added, for example, as nucleation agents, in order to improve the foaming. Examples of suitable antioxidants are sterically hindered phenols.

The embodiment of the invention is not limited to the above explained examples and aspects; instead numerous variants are possible within the range of action of the person skilled in the art.

### LIST OF REFERENCE NUMERALS

1, 1′ Profiled plastic part

1a Hollow profiled plastic part

2 Insulation core, insulation material

3 Funnel

4 (First) extruder

5,5′ Plastic

6, 14 Screw conveyor

7, 15 Motor

8, 16 Transmission

9, 17; 17′; 17″; 17′″ Nozzle

10, 18 Heating element/device

11, 11′ Foamable material (granulate)

12 Funnel

13 (Second) extruder

17a to 17c; Nozzle sections

17a′; 17b′, 17d′,

17a″, 17b″; 17a′″

19 Calibration device

20 Pull-off device

21 Guide plate

22 Nozzle or spray core

23 Perforated sheet (strainer)

24; 24′ Additional part

24a′-24f′ Modules of the additional part

25 Attachment bolt

1. A method of producing a hollow body (1, 1a, 1′) or hollow space foamed with an insulation material (2), the method comprising supplying an expandable starting material of the insulation material to a plastic extrusion apparatus (13), activating the latter under pressure, and, at the time of the discharge from the latter, expanding the starting material into the hollow body or the hollow space with such a high volume expansion gradient that the insulation material formed by the expansion completely fills a cross-section of the hollow body or hollow space immediately at the time of the introduction.

2. The method according to claim 1, wherein the plastic extrusion apparatus (13) is supplied with solid starting material in granulate form (11, 11′).

3. The method according to claim 1, wherein the hollow body (1, 1a, 1′) is an extruded profile made of a plastic material and the insulation material (2) is introduced in a coextrusion process simultaneously with the formation of the profiled plastic part.

4. The method according to claim 1, wherein the hollow body (1, 1a, 1′) is a door or window frame profile.

5. The method according to claim 1, wherein a plastic extrusion apparatus (13) with at least one screw conveyor (6, 14) is used, and the plastic extrusion apparatus is configured and mechanical properties of the starting material (11, 11′) are predetermined so that shearing forces occur that at least contribute to a thermal activation of the starting material.

6. The method according to claim 1, wherein a plastic extrusion apparatus (13) with a heating device (10, 18) is used and the heating device is operated so that it at least contributes to a thermal activation of the starting material (11, 11′).

7. The method according to claim 1, wherein the process of expansion of the starting material (11), at the time of the discharge from the extrusion apparatus (13), is controlled by a special nozzle geometry (17; 17′; 17″; 17′″) which imprints a predetermined cross-section shape on the insulation material flow.

8. The method according to claim 7, wherein, as a result of the nozzle geometry (17; 17′; 17″; 17′″), the implementation includes first a gradual cross-section reduction of the insulation material flow with small gradient over a large length, then maintaining the cross-section constant over a small length, and then a gradual cross-section reduction with large gradient over a small length, and, subsequently or instead, a gradual cross-section increase with medium gradient over a medium length, the latter being followed by an exit through a spray head (23) with a plurality of spray openings.

9. A plastic extrusion apparatus (13) for implementing the method according to claim 1, the apparatus having at least one screw conveyor (6, 14), the screw geometry of which is configured an accordance with the screw cylinder so as to generate high shearing forces in a conveyed starting material (11, 11′) of an insulation material (2), and/or one heating device (10, 18) for heating the starting material.

10. The plastic extrusion apparatus (13) according to claim 9, with an outlet-side nozzle arrangement which is designed for the expansion of a preactivated starting material (11, 11′) with high volume expansion gradient.

11. The plastic extrusion apparatus (13) according to claim 10, wherein the nozzle arrangement has a first nozzle section (17a) of large length, in which the nozzle cross-section decreases continuously with low gradient, a second section of small length (17b) in which the cross-section remains constant, a third nozzle section of small length (17c) in which the nozzle section decreases with large gradient, a fourth nozzle section of medium length (17d) in which the nozzle cross-section increases with medium gradient, and a fifth nozzle section with a plurality of spray openings (23).

12. The plastic extrusion apparatus (13) according to claim 9, wherein the apparatus is configured as a single-screw extruder or single-screw injection molding machine.

13. The plastic extrusion apparatus according to claim 10, wherein the nozzle arrangement is formed in an additional part (24; 24′) which can be attached on the outlet side.
